(19) United States
(12) Patent Application Publication
(10) Pub. No.: US 2013/0117190 A1
(43) Pub. Date: May 9, 2013

(54) COPYRIGHT INFRINGEMENT MANAGEMENT SYSTEM, APPARATUS, AND METHOD

(71) Applicant: Emanuel I. Wald, Laverock, PA (US)

(72) Inventor: Emanuel I. Wald, Laverock, PA (US)

(73) Assignee: Singularis, Inc., Laverock, PA (US)

(21) Appl. No.: 13/290,469

(22) Filed: Nov. 7, 2011

(51) Int. Cl. G06Q 50/18; G06F 17/30

(52) U.S. Cl. 705/310; 707/710

(57) ABSTRACT

A system, apparatus, and method is provided for the copyright infringement lifecycle. Content to be added to a catalogue is received and stored in a database. Material that is same or similar to the content is automatically searched for by deriving and using keywords indicative of the material, and a user is notified of the material that is same or similar to the content. Infringing activity is monitored and content owners' rights are enforced via automatic dispatch of electronic notifications. Defendant pools are built by cross-referencing the physical location of infringing activity and jurisdictions where attorneys are admitted to practice.

### FIELD

The present invention relates to a system, apparatus, and method designed to protect intellectual property rights of contents owners and, more particularly, to a system, apparatus, and method that manages an entire copyright infringement lifecycle.

### BACKGROUND

In order for a person to effectively protect his or her intellectual property rights, the person generally has to constantly be on the lookout for infringing material. Once infringing material is found, the person has to send notices to the alleged infringer and find an attorney that can handle the matter. This can be time consuming and the person may not be able to accurately find and identify infringing material.

### SUMMARY

Certain embodiments of the present invention may provide solutions to the problems and needs in the art that have not yet been fully identified, appreciated, or solved by current infringement management systems. For instance, one or more embodiments of the present invention pertain to registering a user's copyright material and actively searching for infringing material on the Internet. In the case where infringing material is found, the infringing material is monitored and a cease and desist notice is sent to the infringer and the Internet Service Provider (ISP) hosting the infringing material. The system also locates attorneys in the jurisdiction where the infringement occurred, and assists the attorneys in the litigation enforcement process.

In accordance with an embodiment of the present invention, a computer-implemented method is provided. The method receives content to be added to a catalogue and stores the catalogue in a database. The method also automatically searches for infringing material on the Internet by crawling webpages and examining metadata of each webpage for keywords that are same or similar to the content, and notifies a user of the material that is the same or similar to the content.

In yet another embodiment of the present invention, a computer program, embodied on a non-transitory computer readable medium, is provided. The computer program, when executed, is configured to cause a processor to receive content to be added to a catalogue and store the catalogue in a database. The computer program is further configured to cause a processor to automatically search for infringing material on the Internet by crawling webpages and examining metadata of each webpage for keywords that are same or similar to the content, and notify a user of the material that is the same or similar to the content.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a system that can be implemented in one or more embodiments of the present invention.

FIG. 2 illustrates a method for executing a copyright infringement lifecycle, in accordance with an embodiment of the present invention.

FIG. 3 illustrates a method for adding a catalogue and/or content, in accordance with an embodiment of the present invention.

FIG. 4 illustrates a method for searching for infringing material, in accordance with an embodiment of the present invention.

FIG. 5 illustrates a method for monitoring infringing activity, in accordance with an embodiment of the present invention.

FIG. 6 illustrates a method for automated copyright enforcement, in accordance with an embodiment of the present invention.

FIG. 7A illustrates a method for registering attorneys, in accordance with an embodiment of the present invention.

FIG. 7B illustrates a method for initiating a complaint, in accordance with an embodiment of the present invention.

FIG. 7C illustrates a method for tracking the litigation, in accordance with an embodiment of the present invention.

FIG. 8 illustrates a method for providing a user with updates, in accordance with an embodiment of the present invention.

### DETAILED DESCRIPTION OF THE EMBODIMENTS

It will be readily understood that the components of the invention, as generally described and illustrated in the figures herein, may be arranged and designed in a wide variety of different configurations. Thus, the following detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One or more embodiments described herein pertain to a system, apparatus, method, and a computer program that is designed to protect the intellectual property rights of content owners. For instance, the system manages the entire copyright infringement lifecycle by identifying infringing material online, monitoring infringing activity occurring over non-anonymous peer-to-peer file-sharing networks, providing infringement analytics, reducing online piracy levels via ISP notice campaigns, producing evidence that can be used in litigation, and managing the infringement monetization process. The embodiments described herein address the problem of, for example, lost sales of music, video games, software, pictures and films due to unauthorized online file sharing.

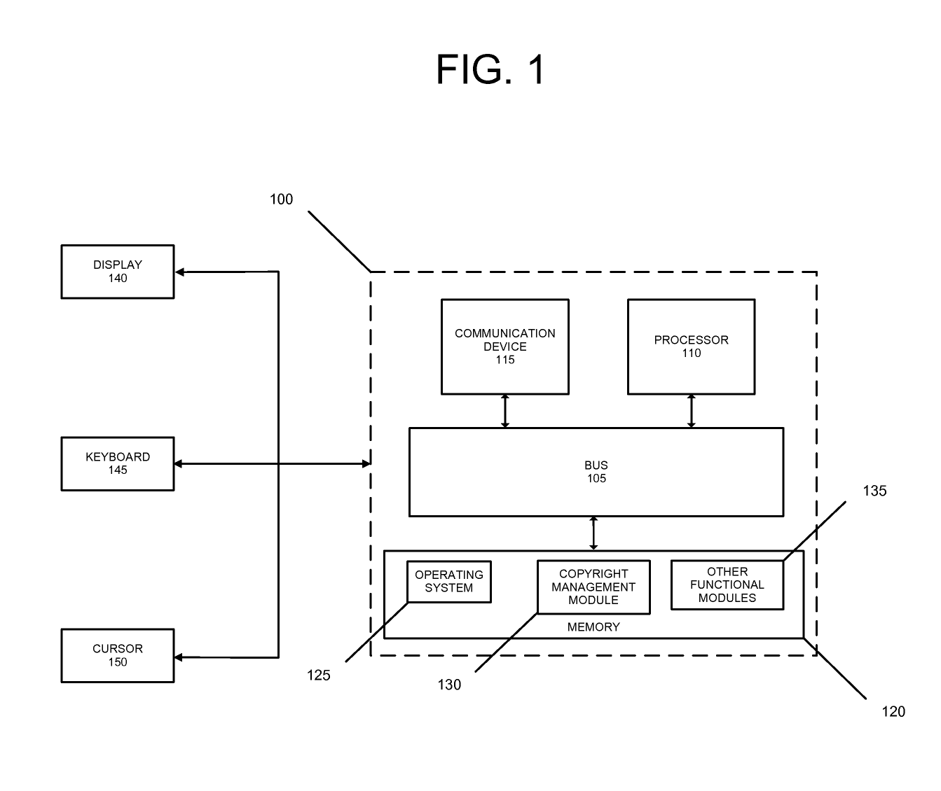

FIG. 1 illustrates a block diagram of a system 100 that can be implemented in one or more embodiments of the present invention. System 100 may include a bus 105 or other communication mechanism that can communicate information and a processor 110, coupled to bus 105, that can process information. Processor 110 can be any type of general or specific purpose processor. System 100 may also include memory 120 that can store information and instructions to be executed by processor 110. Memory 120 can be comprised of any combination of random access memory (“RAM”), read only memory (“ROM”), static storage such as a magnetic or optical disk, or any other type of computer readable medium. System 100 may also include a communication device 115, such as a network interface card, that may provide access to a network.

The computer readable medium may be any available media that can be accessed by processor 110. The computer readable medium may include both volatile and nonvolatile medium, removable and non-removable media, and communication media. The communication media may include computer readable instructions, data structures, program modules, or other data and may include any information delivery media.

Processor 110 can also be coupled via bus 105 to a display 140, such as a Liquid Crystal Display (“LCD”). Display 140 may display information to the user, such as copyrights owned by the user, potential infringing material, etc. A keyboard 145 and a cursor 150, such as a computer mouse, may also be coupled to bus 105 to enable the user to interface with system 100.

According to one embodiment, memory 120 may store software modules that may provide functionality when executed by processor 110. The modules can include an operating system 125 and a copyright management module 130, as well as other functional modules 135. Operating system 125 may provide operating system functionality for system 100. Because system 100 may be part of a larger system, system 100 may include one or more additional functional modules 135 to include the additional functionality, such as a content management module, infringing material discovery module, infringing activity monitoring module, automated copyright enforcement module, litigation and collections module, and an intelligence module.

The content management module allows catalogues to be added to system 100, and content to be added to the catalogues either manually or via bulk import.

The infringing material discovery module is configured to identify potential online infringing material based on the content in the catalogues. The infringing material discovery module assigns a confidence level to the relationship between the infringing material and the content. If the confidence level exceeds a threshold then system 100 can monitor activity and notify the administrator accordingly.

The infringing activity monitoring module probes file sharing networks for activity associated with infringing material and logs results. The infringing activity monitoring module also probes participating peers and listens for incoming communication from peers and logs results.

The automated copyright enforcement module automatically generates one or more notices of copyright infringement that comply with the Digital Millennium Copyright Act (DMCA) and transmits the one or more notices to one or more Internet Service Providers (ISPs). The automated copyright enforcement module also actively monitors ISP and subscriber compliance. For instance, the automated copyright enforcement module determines whether the ISP and the subscriber have complied after receiving the infringement notice.

The litigation and collections management module is configured to register attorneys and attorneys' bar admissions within system 100. The litigation and collections management module can identify the geographic location of the infringers and isolate groups of defendants tied to the jurisdiction where attorneys can practice. The litigation and collections management module can generate exhibits for complaints, discovery documents, and evidence preservation requests.

The intelligence module can access data collected during the activity monitoring process, as well as derived information. The intelligence module can also view case, observation, notice, compliance, and monetization metrics aggregated by categories such as City, State, Country, ISP, University, Title, Author, Date, etc.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

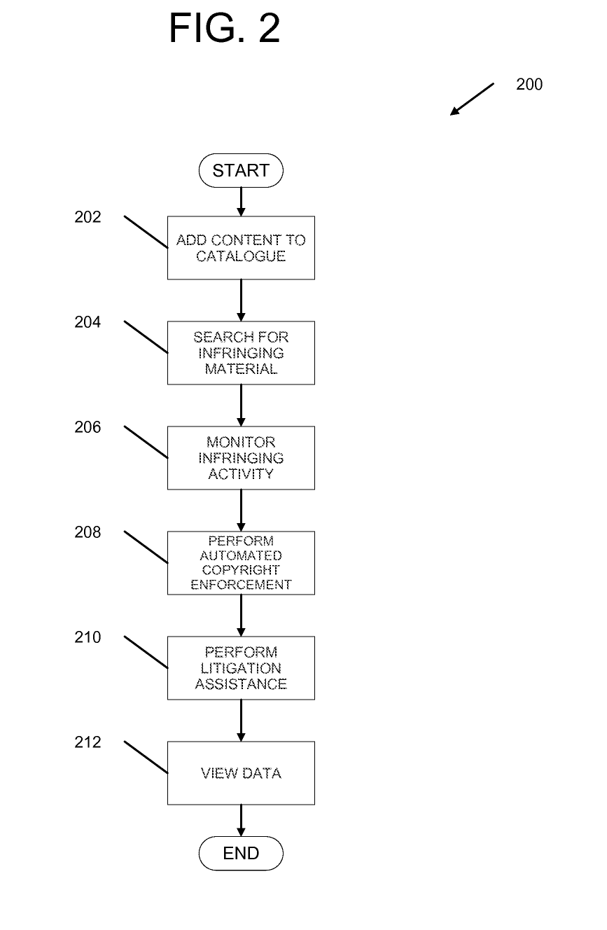

FIG. 2 illustrates a method 200 for executing a copyright infringement lifecycle, in accordance with an embodiment of the present invention. The method may be performed, for example, by the system shown in FIG. 1 in some embodiments. For example, the copyright management module, when executed, can be configured to cause the processor to carry out the steps described below.

At 202, content is added to a catalogue so the copyright management module can monitor for infringing activity. At 204, based on the content within the catalogue, infringing material is searched for and discovered on the Web. At 206, when infringing material is discovered, the infringing material is automatically monitored. At 208, the system performs automated copyright infringement functions. For example, the ISP and/or infringer may be notified of the infringing activity and/or material. At 210, the copyright management module assists in litigation and monetization matters pertain to each infringing activity. At 212, the user can view data pertaining to the copyright infringement using the intelligence module. It should be appreciated that after each step 204, 208, 210, or 212, the user can view the data using the intelligence module.

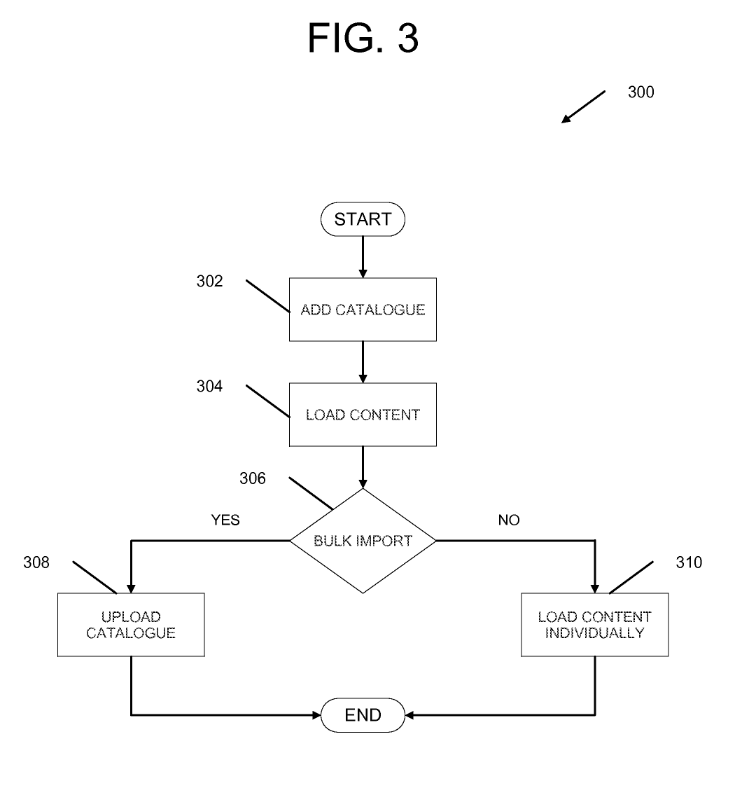

FIG. 3 illustrates a method 300 for adding a catalogue and/or content, in accordance with an embodiment of the present invention. The method may be performed, for example, by the system shown in FIG. 1 in some embodiments. For example, the content management module, when executed, can be configured to cause the processor to carry out the steps described below.

At 302, a catalogue is added or created in a database via a web interface. The catalogue can be for registered U.S. Copyright material and non-registered copyrighted material. The catalogue may also include a plurality of types of content. For instance, if the user is a musician, the catalogue can include content, i.e., a textual description for each musical composition. In the case where the user is in the film industry, the catalogue may include a textual description for each film. At 304, content is added to the catalogue. For instance, content may be the individual copyrighted works that are added to the catalogue. The content is described using information such as author of the copyrighted material, title of the copyrighted material, the year of publication of the copyrighted material, the registration number of the copyrighted material, a description of the copyrighted material, as well as any other information that would be readily appreciated by a person of ordinary skill in the art.

At 306, the user is provided, via the web interface, with the option to perform bulk import of content or manually upload content in the catalogue. If the user selects to perform bulk import of the content, then at 308 the user can enter the information regarding the content in the catalogue and upload the catalogue via the web interface. It should be appreciated that the catalogue can be uploaded in a catalogue import file to the database.

If the user selects to manually upload content, then at 310 the user can add content to the catalogue via the Web interface and upload the catalogue to the database. By uploading the catalogue to the database, the infringing material discovery module can use the content in the catalogue to search for infringing material on the Internet.

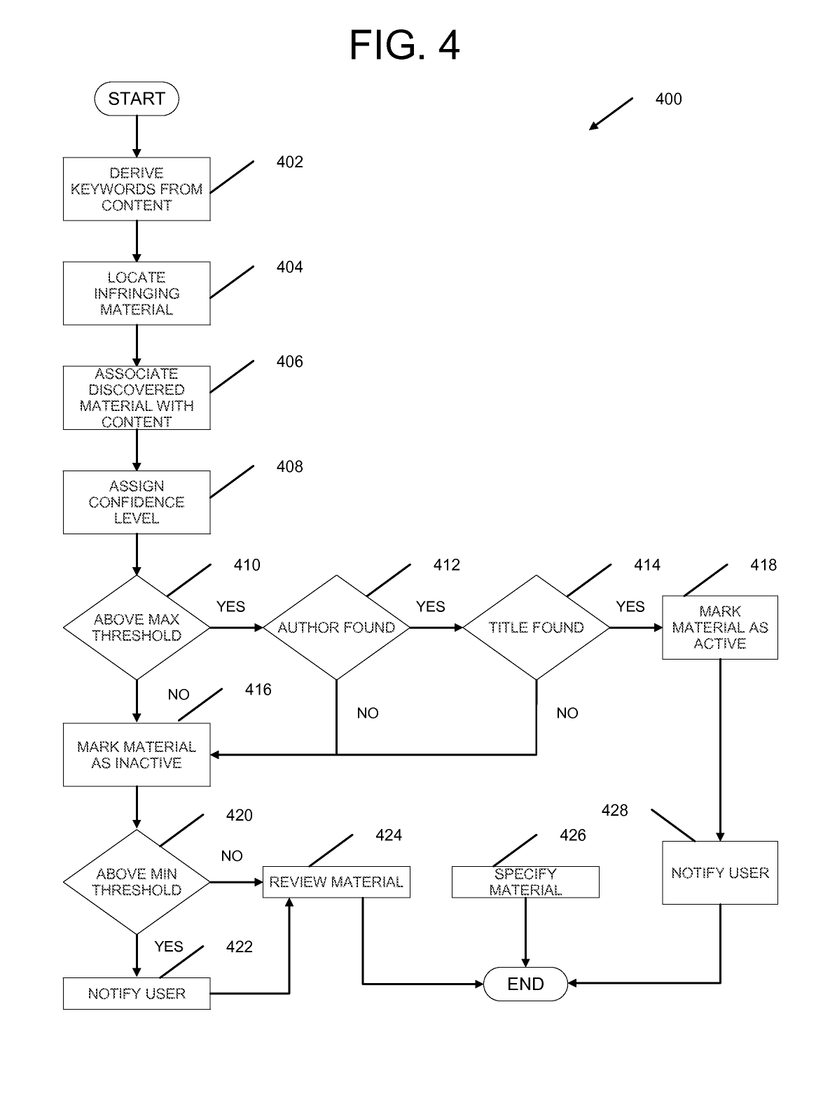

FIG. 4 illustrates a method 400 for searching for infringing material, in accordance with an embodiment of the present invention. The method may be performed, for example, by the system shown in FIG. 1 in some embodiments. For example, the infringing material discovery module, when executed, can be configured to cause the processor to carry out the steps described below.

At 402, for each content item that was added to the catalogue, the infringing material discovery module derives keywords from the content in order to perform a search for infringing material. For example, the infringing material discovery module can derive keywords from the content using the name of the author, the title of the copyrighted material, etc. At 404, the infringing material discovery module searches the Internet and locates infringing material using the derived keywords and phonetically similar keywords. In one embodiment, the infringing material discovery module locates infringing material crawling webpages and examining the metadata of each webpage. However, it should be appreciated that other techniques can be used to locate infringing material on the Internet.

For each item of infringing material that is discovered, the infringing material discovery module at 406 associates the discovered infringing material with the corresponding content. At 408, for each item of infringing material discovered, the infringing material discovery module assigns a confidence level to the relationship between each discovered instance of the infringing material and the associated content. For example, independent weights can be assigned to content author and title in calculating the confidence level of the relationship between material found and content in the catalogue. A ratio can be calculated from the number of content keywords found in the material title, comment, and included file names, and the total number of keywords for that piece of content. This ratio can then be augmented by the weights assigned to the presence of the content author or title in the material title, comment, and included files.

At 410, the infringing material discovery module determines whether the confidence level between the discovered infringing material and the associated content has exceeded a threshold value. For instance, if the confidence level between the discovered infringing material and the associated content is at 98 percent, and the threshold is 95 percent, then the threshold can be considered to be exceeded. It should be appreciated that the confidence level or the threshold value may be set to any percentage by the user, system administrator, etc. If the confidence level has not exceeded the threshold value, then at 416 the infringing material discovery module records the infringing material is inactive.

If the confidence level exceeds or is above the threshold value, then at 412 the infringing material discovery module determines whether the author for the infringing material is found. If the author is not found, then at 416 the infringing material discovery module records the infringing material is inactive.

If the author is found, then at 414 the infringing material discovery module determines whether the title of the infringing material is found. If the title is not found, then at 416 the infringing material discovery module records the infringing material is inactive. If the title is found, then at 418 the infringing material discovery module records the infringing material as active and begins to monitor the infringing material. It should be appreciated that additional or fewer parameters can be included in the process to determine whether to mark the infringing material as active and begin monitoring. The infringing material discovery module can also notify the user (or copyright owner of the newly discovered infringing material at 428.

In the case where the infringing material discovery module records the infringing material as inactive, then at 420 the infringing material discovery module determines whether the confidence level between the infringing material and the associated content is above a minimum threshold. However, in the case that the infringing material was above the maximum threshold, such a determination may not be performed in some embodiments. The minimum threshold can be set to any level that would be appreciated by a person of ordinary skill in the art, and may be a variable threshold. For example, the minimum threshold can be set to be 25 percent, 35 percent, or any percentage. In an alternative embodiment, the minimum threshold level can be a range. This allows the user to receive notification for any discovered infringing activity that falls within the range.

When the confidence level is above the minimum threshold, the infringing material discovery module notifies the user or administrator of a possible content match at 422. This allows the user to review the potentially infringing material via the web interface at 424, and manually activate the discovered infringing material in order for the infringing material to be monitored. For instance, the user can review the results of the discovered infringing material and filter the material by the confidence level. This allows the user to select the discovered infringing material that the user wants to have monitored by the system.

When the confidence level is not above the minimum threshold, the infringing material discovery module does not notify the user of the possible infringing activity, but allows the user to review the possible infringing material via the web interface at 424 and manually activate the infringing material in order for the infringing material to be monitored.

In an alternative embodiment, the infringing material discovery module allows at 426 the user to manually specify a Uniform Resource Locator (URL) of infringing material via the web interface. This allows the infringing material discovery module to monitor infringing activity specified by the user.

It should be appreciated that the infringing material discovery module may run periodically based on the configuration set by the user, system administrator, etc. For instance, the infringing material discovery module can be configured to run every 6 hours, 12 hours, 24 hours, etc. The user or system administrator, for example, can configure the infringing material discovery module to run at various times for each item of content in a catalogue.

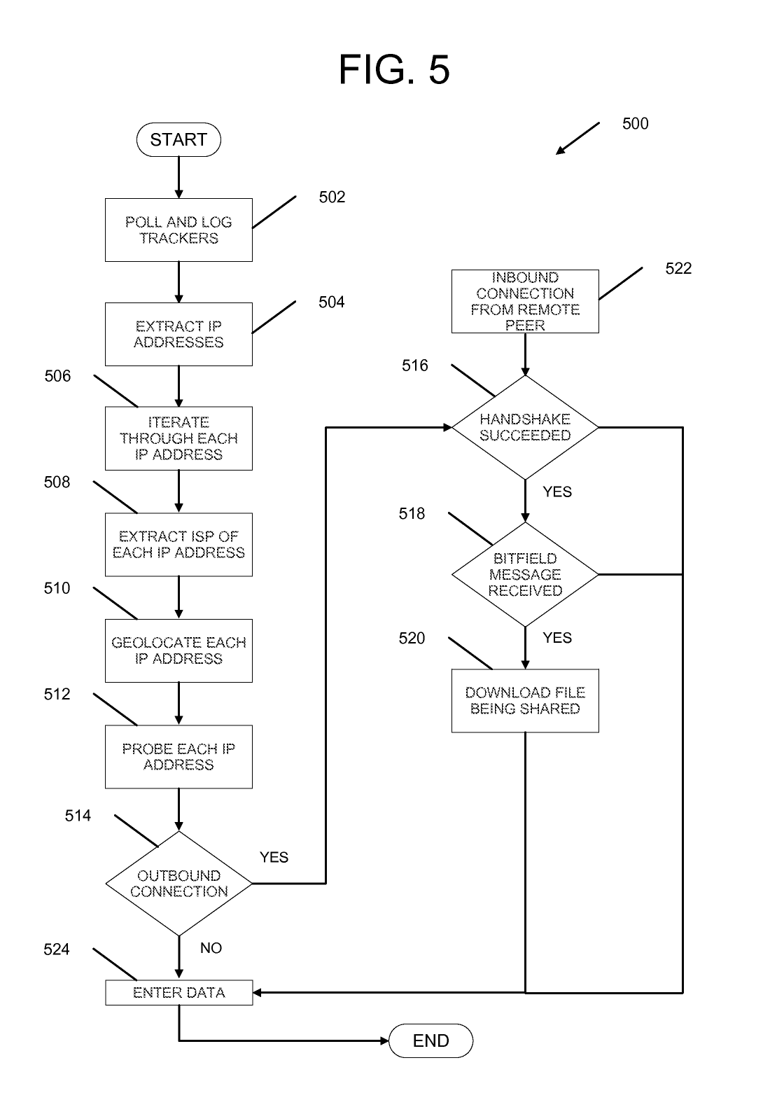

FIG. 5 illustrates a method 500 for monitoring infringing activity, in accordance with an embodiment of the present invention. The method may be performed, for example, by the system shown in FIG. 1 in some embodiments. For example, the infringing activity monitoring module, when executed, can be configured to cause the processor to carry out the steps described below.

Based on the configuration set up by the user or system administrator, the infringing activity monitoring module can be scheduled to run on a periodic basis or after expiration of a time interval.

At 502, the infringing activity monitoring module connects to the directories or registries in the peer-to-peer network or trackers. For instance, the infringing activity monitoring module is configured to poll trackers of active torrents, log tracker responses, and record a timestamp for each response.

For each tracker response, at 504, the infringing activity monitoring module extracts Internet Protocol (IP) addresses and ports of peers participating in torrent swarms. The infringing activity monitoring module iterates at 506 through each IP address that was found and records metadata from the regional Internet directories or registries. For instance, the infringing activity monitoring module may be configured to log the WHOIS record from appropriate regional Internet registries. This allows the infringing activity monitoring module to determine who or what entity owns the IP address hosting the infringing material, the geolocation of the entity and IP address, etc. At 508, the infringing activity monitoring module extracts the Internet Service Provider (ISP) of each IP address found from the corresponding WHOIS record.

Based on the information contained in the WHOIS record, the infringing activity monitoring module geolocates at 510 each IP address found. This will help, as will be described below, to locate the attorneys in the region where the infringing activity is occurring. At 512, the infringing activity monitoring module probes each IP address found for the infringing material, and for any additional communication that would indicate that the IP address has the infringing material.

At 514, the infringing activity monitoring module determines whether an outbound connection to the peer has been established. If connection is not established, then at 524 the infringing activity monitoring module inputs data into an automated copyright enforcement database, a litigation database, and an intelligence database. For instance, the data indicates that no connection has been established with the peer. This allows the automated copyright enforcement module, the litigation module, and intelligence module to extract data from the pertinent databases and carryout their respective functions, as will be described in further detail below.

If a connection has been established, then at 516 the infringing activity monitoring module determines whether a handshake was successful. If the handshake was not successful, then at 524 the infringing activity monitoring module inputs data into an automated copyright enforcement database, a litigation database, and an intelligence database. For instance, the infringing activity monitoring module is configured to enter information indicating that the handshake was not successful. If the handshake was successful, then at 518 the infringing activity monitoring module determines whether a bitfield message was received. The bitfield message includes a reference to a portion of the infringing material. If the bitfield message was not received, then at 524 the infringing activity monitoring module inputs data indicating that a bitfield message was not received into an automated copyright enforcement database, a litigation database, and an intelligence database.

If the bitfield message was received, then at 520 the infringing activity monitoring module downloads the file being shared. The file being downloaded may contain a segment or portion of the infringing activity. At 524, the infringing activity monitoring module inputs data related to the infringing activity into an automated copyright enforcement database, a litigation database, and an intelligence database.

In one or more embodiments, the infringing activity monitoring module can listen, on its own IP address, for any inbound connections from a remote peer associated with the infringing material. In certain cases, the infringing activity monitoring module can receive at 522 an inbound connection from a remote peer. In this case, the infringing activity monitoring module at 516 determines whether a handshake was successful. If the handshake was not successful, then at 524 the infringing activity monitoring module inputs data related to the infringing activity into an automated copyright enforcement database, a litigation database, and an intelligence database. If the handshake was successful, then at 518 the infringing activity monitoring module determines whether a bitfield message was received. If the bitfield message is received, then the file with the infringing material is downloaded at 520.

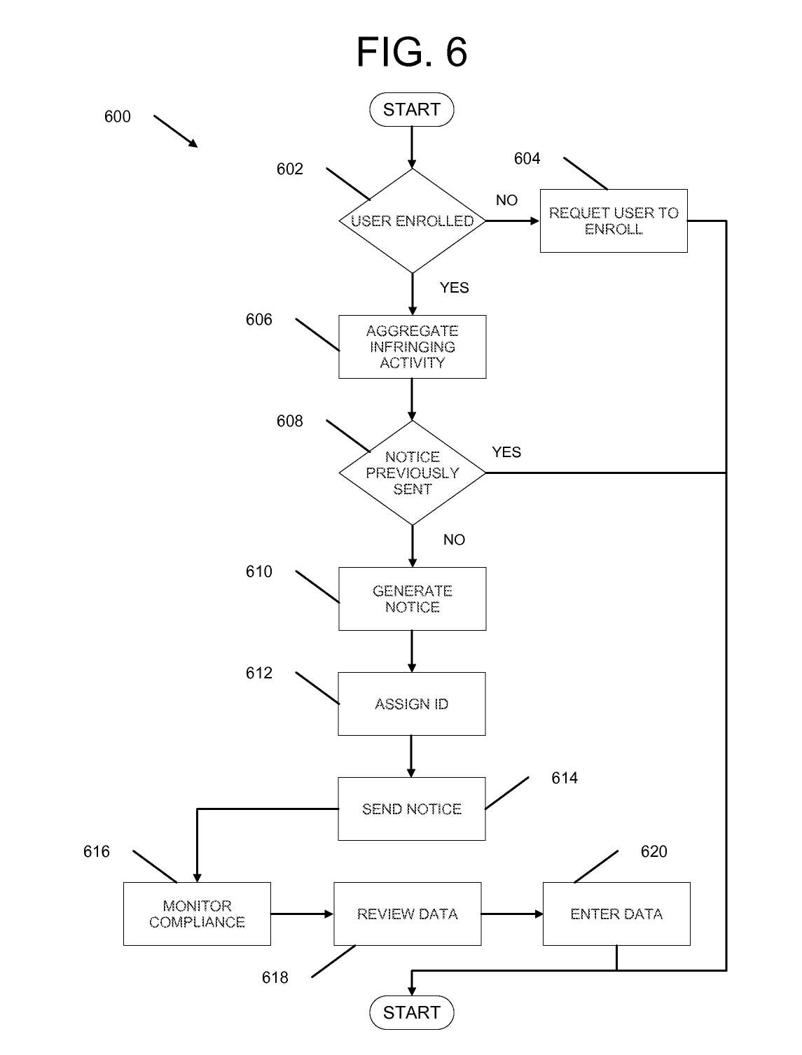

FIG. 6 illustrates a method 600 for automated copyright enforcement, in accordance with an embodiment of the present invention. The method may be performed, for example, by the system shown in FIG. 1 in some embodiments. For example, the automated copyright enforcement module, when executed, can be configured to cause the processor to carry out the steps described below.

It should be appreciated that the automated copyright enforcement process may run on a periodic basis based on the configuration set up by the user or system administrator.

The automated copyright enforcement module determines whether the user has enrolled in automated copyright enforcement at 602. If the user has not registered, then the automated copyright enforcement module transmits a message to the user requesting that the user register or enroll in automated copyright enforcement at 604. If, however, the user has registered or when the user registered in automated copyright enforcement, the automated copyright enforcement module aggregates recent infringing activity and groups the infringing activity by the ISP at 606. This allows a single email notification to be sent to the ISP. The notice may include a list of IP addresses associated with the ISP and indicate that the IP addresses currently contain infringing material. In other words, the notice acts as a “take down” notice.

At 608, the automated copyright enforcement module determines whether a notice has been transmitted to the ISP for each IP address related to the infringing activity. For instance, the automated copyright enforcement module determines whether a notice was sent to the ISP in the past week pertaining to the infringing activity, or any time frame that would be set up by the system administrator or user.

If a notice was sent to the ISP pertaining to the infringing activity, then the automated copyright enforcement module omits the IP address with the infringing activity that was in the previously sent notice, and waits until a predetermined time period before sending another notice or takes an alternative action. If, however, a notice was not sent to the ISP, the automated copyright enforcement module can generate at 610 a Digital Millennium Copyright Act (DMCA) complaint copyright infringement notice to inform the ISP of infringement by the owner of the IP address. In this embodiment, the notice can include the IP address of the infringement, port, torrent name, infohash, a list of files that are infringing, the size of each infringing file, first observation of the infringement, last observation of the infringement, as well as other information that would be appreciated by a person of ordinary skill in the art.

At 612, the automated copyright enforcement module assigns a unique identification (ID) to the copyright notice. At 614, the automated copyright enforcement module can send a digitally signed DMCA complaint notice to the ISP. Once the notice is sent to the ISP, the automated copyright enforcement module routinely monitors at 616 compliance by the ISP. For instance, the automated copyright enforcement module determines whether the ISP has complied with the notice by tracking the ISP response using the unique ID assigned to the notice, as well as confirms cessation of the infringing activity.

At 618, the automated copyright enforcement module allows the user to review the notice, the response from the ISP, the content, infringing activity detail, and the status of the infringing activity via the web interface. At 620, data pertaining to the notice and the activity is entered into the intelligence database to be used by the intelligence module.

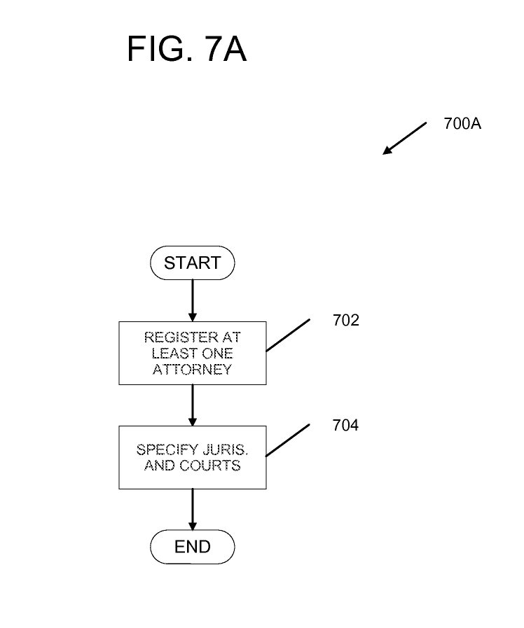

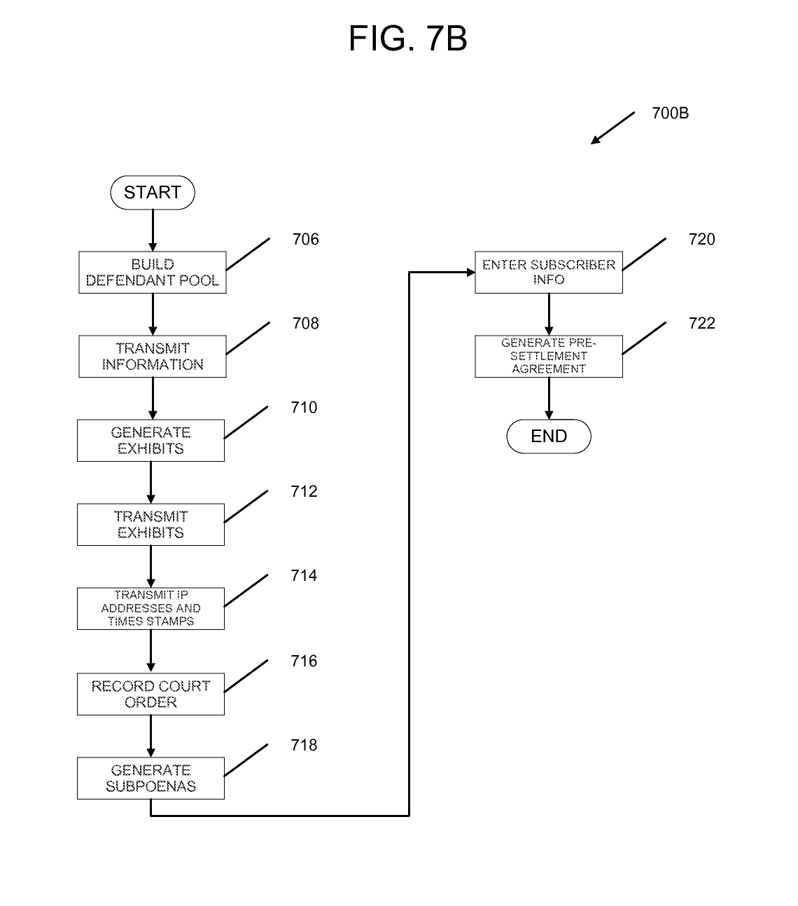

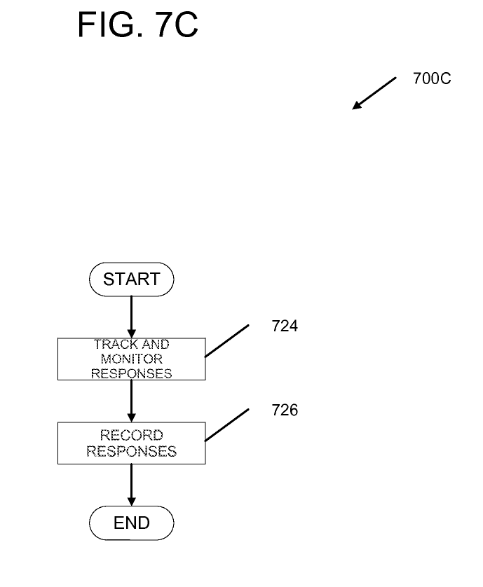

FIG. 7A illustrates a method 700A for registering attorneys, in accordance with an embodiment of the present invention. The method may be performed, for example, by the system shown in FIG. 1 in some embodiments. For example, the litigation module, when executed, can be configured to cause the processor to carry out the steps described below.

In this embodiment, the litigation module provides a web interface for attorneys at various geographic locations to register at 702. At 704, the litigation module allows each attorney to specify the jurisdictions and courts before which the attorney is admitted to practice.

FIG. 7B illustrates a method 700B for initiating a complaint, in accordance with an embodiment of the present invention. The method may be performed, for example, by the system shown in FIG. 1 in some embodiments. For example, the litigation module, when executed, can be configured to cause the processor to carry out the steps described below.

At 706, the litigation module creates a defendant pool by cross-referencing jurisdictions of courts in which an attorney is admitted to practice with geolocations of IP addresses involved in infringing activity. For example, if the attorney is admitted to practice in the State of California and there are 10 IP addresses involved in infringing activity, then a defendant pool is built based on the attorney's jurisdiction and the IP addresses involved in the infringing activity.

At 708, the litigation module transmits information pertaining to the defendants and the infringing activity to the attorney to initiate a civil action against the defendants. A notification can also be sent to the user/owner of the copyright material. The litigation module then generates at 710 exhibits for the complaint, exhibits for the expedited discovery motions, and exhibits for the subpoenas. At 712, the exhibits are transmitted to the attorney in order to file the copyright infringement complaint.

At 714, the litigation module then transmits IP addresses and timestamps in the defendant pool to the attorney so the attorney can file a motion for expedited discovery of subscriber information. When a court grants the motion for expedited discovery, the litigation module can receive such information and enter or record the information pertaining to the court order into the litigation database at 716. At 718, the litigation module may generate a subpoena form and/or provide relevant information for the matter in order for the attorney to send the subpoenas for subscriber information to the ISPs. When a response is received from the ISP, the litigation module can then enter at 720 subscriber information and associate the defendants or, in the alternative, the attorney using the web interface can enter subscriber information and associate the defendants accordingly.

At 722, the litigation module provides the attorney with information to generate and send pre-settlement letters for defendants.

FIG. 7C illustrates a method for tracking the litigation, in accordance with an embodiment of the present invention. The method may be performed, for example, by the system shown in FIG. 1 in some embodiments. For example, the litigation module, when executed, can be configured to cause the processor to carry out the steps described below.

At 724, the user or attorney can log onto the system via the web interface to track or monitor each case. For instance, the litigation module provides information such as case status, settlement offer date, settlement amount, and settlement execution date, as well as any other information that would be appreciated by a person of ordinary skill in the art. The litigation module also allows the attorney or user to record at 726 the defendant responses.

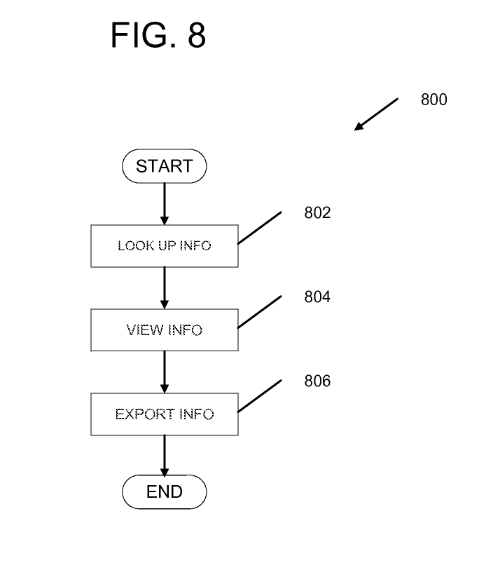

FIG. 8 illustrates a method for providing a user with updates, in accordance with an embodiment of the present invention. The method may be performed, for example, by the system shown in FIG. 1 in some embodiments. For example, the intelligence module, when executed, can be configured to cause the processor to carry out the steps described below.

At 802, the intelligence module allows the user, via the web interface, to look up information such as IP addresses of infringing activity and review comprehensive observation logs detailing the ISP, geolocation of the infringers and the attorneys, ports, observation dates of infringing activity, content, infringing material, trackers, search engines, client software, connection types, percentage of infringing material being downloaded, etc.

At 804, the user can also view, via the web interface, other information such as the IP address of the infringing activity, torrent, tracker, search engine, infringement notices, a compliance tabulation of infringing activity summarized by date, time, content, country, region, city, ISP, and/or educational institution, etc. At 806, information viewed in steps 802 and 804 can be exported to a spreadsheet, word document, PDF, etc.

The method steps shown in FIGS. 2-8 may be performed, in part, by a computer program, encoding instructions for a nonlinear adaptive processor to cause at least the methods described in FIGS. 2-8 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the method described in FIGS. 2-8, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
receiving content to be added to a catalogue and storing the catalogue in a database;
automatically searching for infringing material on the Internet by crawling webpages and examining metadata of each webpage for keywords that are same or similar to the content; and
notifying a user that the material that is same or similar to the content.

2. The computer-implemented method of claim 1, wherein the receiving of the content comprises:
receiving a bulk import of the content from the user or manually receiving the content from the user.

3. The computer-implemented method of claim 1, further comprising:
assigning a confidence level between the material and the content; and
marking the material as active when the confidence level exceeds a maximum threshold value in order for the material to be monitored, or marking the material as inactive when the confidence level is below the maximum threshold, wherein the keywords comprise an author of the content and a title of the content.

4. The computer-implemented method of claim 3, further comprising:
notifying a user of the content of possible infringing material when the confidence level is above a minimum threshold.

5. The computer-implemented method of claim 1, further comprising:
actively monitoring the material for infringement by polling trackers of active torrents, logging tracker responses, and recording a timestamp of the responses;
extracting Internet Protocol (IP) addresses and ports of peers participating in torrent swarms from tracker responses;
iterating through each of the IP addresses to log information pertaining to the IP addresses; and
extracting an Internet Service Provider for each IP address from the logged information.

6. The computer-implemented method of claim 5, further comprising:
receiving a bitfield message when an outbound connection is established with a peer and a handshake has succeeded, wherein the bitfield message comprises data related to the material.

7. The computer-implemented method of claim 1, further comprising:
generating a notice of infringement to be sent to an Internet Service Provider (ISP); and
assigning an identification (ID) to the notice and transmitting the notice to the ISP.

8. The computer-implemented method of claim 7, further comprising:
monitoring compliance by the ISP based on an ISP response, the ID associated with the notice and monitoring the IP address comprising the material.

9. The computer-implemented method of claim 1, further comprising:
creating a pool of defendants based on a geographical location of Internet Protocol (IP) addresses containing infringing material and a geographical location of one or more attorneys.

10. A computer program embodied on a non-transitory computer readable medium, the computer program configured to cause a processor to:
receive content to be added to a catalogue and store the catalogue in a database;
automatically search for infringing material on the Internet by crawling webpages and examining metadata of each webpage for keywords that are same or similar to the content; and
notify a user of the material that is the same or similar to the content.

11. The computer program of claim 10, wherein the content is received via a bulk import or manually.

12. The computer program of claim 10, wherein the computer program is further configured to cause the processor to:
assign a confidence level between the material and the content; and
mark the material as active when the confidence level exceeds a maximum threshold value in order for the material to be monitored, or mark the material as inactive when the confidence level is below the maximum threshold,
wherein the keywords comprise author of the content and title of the content.

13. The computer program of claim 12, wherein the computer program is further configured to cause the processor to:
notify a user of the content of possible infringing material when the confidence level is above a minimum threshold.

14. The program of claim 10, wherein the computer program is further configured to cause the processor to:
actively monitor the material for infringement by polling trackers of active torrents, logging tracker responses, and recording a timestamp of the responses;
extract Internet Protocol (IP) addresses and ports of peers participating in torrent swarms from tracker responses;
iterate through each of the IP addresses to log information pertaining to the IP addresses; and
extract an Internet Service Provider for each IP address from the logged information.

15. The computer program of claim 14, wherein the computer program is further configured to cause the processor to:
receive a bitfield message when an outbound connection is established with a peer and a handshake has succeeded, wherein the bitfield message comprises data related to the material.

16. The computer program of claim 10, wherein the computer program is further configured to cause the processor to:
generate a notice of infringement to be sent to an Internet Service Provider (ISP); and
assign an identification (ID) to the notice and transmit the notice to the ISP.

17. The computer program of claim 16, wherein the computer program is further configured to cause the processor to:
monitor compliance by the ISP based on an ISP response, the ID associated with the notice and monitor the IP address comprising the material.

18. The computer program of claim 10, wherein the computer program is further configured to cause the processor to:
create a pool of defendants based on a geographical location of Internet Protocol (IP) addresses containing infringing material and a geographical location of one or more attorneys.
